(19) United States
(12) Patent Application Publication
(10) Pub. No.: US 2014/0271388 A1
(43) Pub. Date: Sep. 18, 2014

(54) Formation and Stability of Cu-Mn Spinel Phase for ZPGM Catalyst Systems

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: CDTI, Ventura, CA (US)

(21) Appl. No.: 14/098,070

(22) Filed: Dec. 5, 2013

Related U.S. Application Data
(63) Continuation-in-part of application No. 13/849,169, filed on Mar. 22, 2013.
Application No. 13/849,169 is a continuation-in-part of application No. 13/849,230, filed on Mar. 22, 2013.
(60) Provisional application No. 61/791,721, filed on Mar. 15, 2013.
(60) Provisional application No. 61/791,838, filed on Mar. 15, 2013.

(51) Int. Cl. B01J 23/889

(52) U.S. Cl. CPC B01J 23/8892
USPC 422/170; 423/599

(57) ABSTRACT

Optimized Cu—Mn spinel compositions, with optimal spinel phase formation and phase stability properties, for a plurality of ZPGM catalysts in underfloor and closed-loop coupled catalyst applications are disclosed. Plurality of Cu—Mn spinel compositions are prepared with variations of molar ratios. Effect of calcination temperature is analyzed to determine spinel phase formation and phase stability, as well as the effect of calcination temperature on lattice parameter of spinel, as correlated to spinel phase formation and phase stability of optimal Cu—Mn spinel compositions disclosed. Disclosed Cu—Mn spinels with enhanced spinel phase formation and phase stability may be suitable for ZPGM catalyst systems used in a vast number of TWC applications.

### CROSS-REFERENCE TO RELATED APPLICATIONS

This application is a continuation-in-part of U.S. patent application Ser. Nos. 13/849,169 and 13/849,230, filed Mar. 22, 2013, respectively, and claims priority to U.S. Provisional Application Nos. 61/791,721 and 61/791,838, filed Mar. 15, 2013, respectively, and is related to U.S. patent application Ser. No. 14/090,861, filed Nov. 26, 2013, entitled System and Methods for Using Synergized PGM as a Three-Way Catalyst.

### BACKGROUND

1. Technical Field

This disclosure relates generally to catalyst systems, and, more particularly, to formation of Cu—Mn spinel phase and thermal stability of Cu—Mn spinel for use in Zero Platinum Group Metal (ZPGM) catalyst systems.

2. Background Information

Regulatory standards for acceptable emissions are continually revised in response to human health issues and air-quality concerns. Strict-compliance regulatory standards have been adopted worldwide to control emissions of oxides of nitrogen (NOₓ), particulate matters (PM), carbon monoxide (CO), and carbon dioxide (CO₂) from various sources, such as automobiles, utility plants, and processing and manufacturing plants, amongst others.

Catalysts to control toxic emissions have a composite structure consisting of transition metal nano-particles or ions dispersed and supported on the surface of a support material. Said support materials are either micro-particles with a very large specific surface area or a highly porous matrix. A requirement for the materials used is that the catalyst exhibits a very high level of heat resistance and be capable of ensuring stability and reliability in long-term service. Currently, at higher temperatures at which the catalyst functions, the catalytic centers become massed together or agglomerated, which in turn decreases the effective surface area to result in the gradual degradation of the catalytic functions.

Catalyst systems are generally fabricated using platinum group metals (PGM) which are characterized by a small market circulation volume, constant fluctuations in price, and constant risk to stable supply, variables that drive up their cost. These facts are conducive to the realization of catalysts that are substantially free from PGM.

Catalytic materials used in TWC applications have changed, and the new materials have to be thermally stable under the fluctuating exhaust gas conditions. The attainment of the requirements regarding the techniques to monitor the degree of the catalyst's deterioration/deactivation demands highly active and thermally stable catalysts.

According to the foregoing reasons, there is a continuing need to provide materials able to perform in a variety of environments, which may vary in a number of ways, using synergistic effects derived from tools of catalyst design and synthesis methods, as well as it may be desirable to have catalyst systems that may include a new generation of materials. These are very important elements for the advancement of TWC technology to effect emission reduction across a range of temperature and operating conditions, while maintaining or even improving upon the thermal and chemical stability under normal operating conditions and up to the theoretical limit in real catalysts.

### SUMMARY

Present disclosure may provide Cu—Mn spinel compositions which may show optimal spinel phase formation and phase stability properties for a plurality of ZPGM catalysts which may be used in underfloor and closed-loop coupled catalyst applications.

It is an object of the present disclosure to determine active phase formation and phase stability of a plurality of Cu—Mn compositions prepared at a plurality of molar ratios. The Cu—Mn compositions may be prepared in the form of aqueous slurry of Cu and Mn nitrates, which after washing and filtering with distilled water may be dried and calcined at different temperatures. The Cu—Mn composition may be subsequently ground to fine powder for XRD analysis. This process may enable the temperature at which Cu—Mn spinel may be formed, as well as the highest temperature at which the spinel may be stable to select optimal catalyst application for a particular Cu—Mn spinel as underfloor or closed-loop coupled catalyst. The temperature of spinel formation may be used as the temperature of firing during catalyst manufacturing, and the temperature of stability may point to a selected application.

According to embodiments in the present disclosure, in order to determine spinel phase formation and stability, bulk powder samples of Cu—Mn spinel structure may be formed with variations of Cu—Mn molar ratios using the general formulation CuₓMn₃₋ₓO₄, where X may be variable of different molar ratios for the preparation of Cu—Mn bulk powder samples. Spinel phase formation, phase stability of the Cu—Mn spinel phase, and effect of temperature on crystallite size of the Cu—Mn spinel phase may be subsequently analyzed/measured using X-ray diffraction (XRD) analyses. The plurality of variations in present disclosure that may result from successive XRD analysis may produce corresponding phase diagrams. XRD data may then be analyzed and a new phase may be determined and selected in conformity with a different calcination temperature. This calibration may lead to improved variations to produce optimal performance and durability of Cu—Mn catalysts.

It may be found from the present disclosure that although the catalytic activity, and thermal and chemical stability of a catalyst during real use may be affected by factors, such as the chemical composition of the catalyst, the formation of a spinel phase and phase stability of the Cu—Mn spinel formulation may provide an indication that for catalyst applications, and, more particularly, for catalyst systems, the chemical composition of the Cu—Mn bulk powders may show enhanced stability at high temperature of operation, and from a catalyst manufacturer's viewpoint, an essential advantage given the economic factors involved and the flexibility for use in underfloor and closed-loop coupled catalyst applications.

Numerous objects and advantages of the present disclosure may be apparent from the detailed description that follows and the drawings which illustrate the embodiments of the present disclosure, and which are incorporated herein by reference.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 shows XRD analysis for spinel phase formation and phase stability of Cu_{0.2}Mn_{2.8}O₄ spinel at different firing temperatures, according to an embodiment.

FIG. 2 depicts XRD analysis for spinel phase formation and phase stability of Cu_{0.5}Mn_{2.5}O₄ spinel calcined at about 600° C., according to an embodiment.

FIG. 3 illustrates XRD analysis for spinel phase formation and phase stability of Cu_{0.5}Mn_{2.5}O₄ spinel calcined at about 900° C., according to an embodiment.

FIG. 4 shows XRD analysis for spinel phase formation and phase stability of Cu_{0.5}Mn_{2.5}O₄ spinel calcined at about 1,000° C., according to an embodiment.

FIG. 5 depicts XRD analysis for spinel phase formation and phase stability of Cu_{0.5}Mn_{2.5}O₄ spinel calcined at about 1,100° C., according to an embodiment.

FIG. 6 shows XRD analysis for spinel phase formation phase stability of Cu_{1.0}Mn_{2.0}O₄ spinel calcined at about 600° C., according to an embodiment.

FIG. 7 illustrates XRD analysis for spinel phase formation and phase stability of Cu_{1.0}Mn_{2.0}O₄ spinel at different firing temperatures, according to an embodiment.

FIG. 8 shows XRD analysis for spinel phase formation and phase stability of Cu_{1.0}Mn_{2.0}O₄ spinel fired at about 1,100° C., according to an embodiment.

FIG. 9 illustrates XRD analysis for spinel phase formation and phase stability of Cu_{1.5}Mn_{1.5}O₄ spinel fired at about 900° C., according to an embodiment.

FIG. 10 depicts variation of lattice parameters for spinel phase of Cu_{0.5}Mn_{2.5}O₄ and Cu_{1.0}Mn_{2.0}O₄ spinels fired at different temperatures, according to an embodiment.

### DETAILED DESCRIPTION

In the following detailed description, reference is made to the accompanying drawings, which form a part hereof. In the drawings, which are not necessarily to scale or to proportion, similar symbols typically identify similar components, unless context dictates otherwise with emphasis being placed upon illustrating the principles of the invention. The illustrative embodiments described in the detailed description, drawings and claims, are not meant to be limiting. Other embodiments may be used and/or other changes may be made without departing from the spirit or scope of present disclosure.

### DEFINITIONS

As used here, the following terms have the following definitions:

“Platinum group metal (PGM)” refers to platinum, palladium, ruthenium, iridium, osmium, and rhodium.

“Zero platinum group metal (ZPGM)” refers to metals not included in the platinum group metals.

“Catalyst” refers to one or more materials that may be of use in the conversion of one or more other materials.

“Calcination” refers to a thermal treatment process applied to solid materials, in presence of air, to bring about a thermal decomposition, phase transition, or removal of a volatile fraction at temperatures below the melting point of the solid materials.

“Three-way catalyst” refers to a catalyst that may achieve three simultaneous tasks: reduce nitrogen oxides to nitrogen and oxygen, oxidize carbon monoxide to carbon dioxide, and oxidize unburnt hydrocarbons to carbon dioxide and water.

“Treating, treated, or treatment” refers to drying, firing, heating, evaporating, calcining, or mixtures thereof.

“Spinel” refers to any of various mineral oxides of magnesium, iron, zinc, or manganese in combination with aluminum, chromium, copper or iron with AB₂O₄ structure.

“Lattice parameter” refers to the constant distances between unit cells in a three dimensional crystal lattice, referred to as a, b, and c, and angles between sides, referred to as α, β, and γ.

“Conversion” refers to the chemical alteration of at least one material into one or more other materials.

“X-ray diffraction or XRD analysis” refers to the analytical technique that investigates crystalline material structure, including atomic arrangement, crystalline size, and imperfections in order to identify unknown crystalline materials (e.g. minerals, inorganic compounds).

### DESCRIPTION OF THE DRAWINGS

Cu—Mn Material Composition and Preparation

The disclosed material compositions in the present disclosure may be prepared as chemical compositions substantially free from PGM to prepare Cu—Mn bulk powders which may be used as a raw material for a large number of catalyst applications, and, more particularly, in TWC systems. The powder material may be prepared from a stoichiometric or non-stoichiometric Cu—Mn spinel structure using variations of Cu—Mn molar ratios in the general formulation CuₓMn₃₋ₓO₄, where X may be variable of different molar ratios using co-precipitation method as known in the art.

Cu—Mn solution may be prepared by mixing the appropriate amount of Mn nitrate solution (MnNO₃) and Cu nitrate solution (CuNO₃), with water to make solution at different molar ratios according to formulation CuₓMn₃₋ₓO₄. Suitable Cu loadings may include loadings in a range of about 10% to about 15% by weight. Suitable Mn loadings may include loadings in a range of about 15% to about 25% by weight. After mixing both Cu and Mn nitrate, for which an appropriate amount of one or more of sodium hydroxide (NaOH) solution, sodium carbonate (Na₂CO₃) solution, ammonium hydroxide (NH₄OH) solution, tetraethyl ammonium hydroxide (TEAH) solution and other suitable base solutions may be added to adjust pH of the solution at desired value. The precipitated slurry may be aged overnight while stirring at room temperature.

For preparation of Cu—Mn bulk powder, after aging and stirring, the slurry may undergo filtering and washing with distilled water. The resulting material may be dried overnight at about 120° C. and subsequently calcined at a plurality of temperatures within a range of about 500° C. to about 1,100° C. for about 5 hours. The prepared powder at different calcination temperatures may be subsequently ground to fine grain to form bulk powder.

XRD Analysis for Spinel Phase Formation and Spinel Phase Stability of Cu—Mn Spinel Structures

Spinel phase formation, phase stability of the Cu—Mn spinel phase, and effect of temperature on crystallite size of the Cu—Mn spinel phase may be subsequently analyzed/measured using X-ray diffraction (XRD) analyses. The plurality of variations in present disclosure that may result from successive XRD analysis may produce corresponding phase diagrams. XRD data may then be analyzed and a new phase may be determined and selected in conformity with a different calcination temperature. This calibration may lead to improved variations to produce optimal performance and durability of Cu—Mn catalysts. The XRD analysis may be conducted to determine the phase structure Cu—Mn materials that according to principles in the present disclosure may be calcined at temperatures within the range of about 500° C. to about 1,100° C. for about 5 hours.

The XRD patterns are measured on a Rigaku® powder diffractometer (MiniFlex™) using Cu Ka radiation in the 2-theta range of 15-80° with a step size of 0.02° and a dwell time of 1 second. The tube voltage and current were set at 40 kV and 30 rnA, respectively. The resulting diffraction patterns are analyzed using the International Centre for Diffraction Data (ICDD) database and crystallite sizes may be calculated by means of the Scherrer equation as known in the art. The effect of calcining (firing) temperature in the phase stability of the Cu—Mn spinel phase for all Cu—Mn spinel structures in present disclosure may be analyzed/measured using XRD analysis to confirm the spinel phase formation and phase stability of all Cu—Mn spinel structures in present disclosure.

XRD analysis may also provide an indication that for catalyst applications, and, more particularly, for catalyst systems, the chemical composition of the Cu—Mn bulk powders may show enhanced stability at high temperature of operation, as well as flexibility for use in underfloor and closed-loop coupled catalyst applications.

The following examples are intended to illustrate the scope of the disclosure. It is to be understood that other procedures known to those skilled in the art may alternatively be used.

### EXAMPLES

### Example #1

### Cu_{0.2}Mn_{2.8}O₄ Bulk Powder

Cu—Mn solution may be prepared by mixing the appropriate amount of Mn nitrate solution (MnNO₃) and Cu nitrate solution (CuNO₃), with water to make solution at specific molar ratio according to formulation CuₓMn₃₋ₓO₄, in which X may take values of 0.2. For preparation of Cu_{0.2}Mn_{2.8}O₄ bulk powder, after precipitation of Cu—Mn solution with appropriate base solution, the slurry may undergo filtering and washing followed by drying calcination at a plurality of temperatures of about 700° C., 900° C., and 1,100° C. for about 5 hours. The prepared powder at different calcination temperatures may be subsequently ground to fine grain to form bulk powder.

FIG. 1 shows XRD analysis 100 for spinel phase formation and spinel phase stability of Cu_{0.2}Mn_{2.8}O₄ spinel in example #1, at different firing temperatures, according to an embodiment. XRD spectrum 102 shows Cu_{0.2}Mn_{2.8}O₄ spinel calcined at temperature of about 700° C., XRD spectrum 104 shows Cu_{0.2}Mn_{2.8}O₄ spinel calcined at temperature of about 900° C.; and XRD spectrum 106 show Cu_{0.2}Mn_{2.8}O₄ spinel calcined at temperature of about 1,100° C.

As may be observed in FIG. 1, Solid lines 108 correspond to Cu—Mn spinel, the remaining diffraction peaks correspond mostly to a phase of Mn₂O₃ for calcination temperatures of about 700° C. and about 900° C. respectively, and Mn₃O₄ at calcination temperature of about 1,100° C.

Partial formation of Cu—Mn spinel occurs at 700° C. As seen, the formation of Cu—Mn spinel phase partially takes place at very high temperature and shows stability at about 1,100° C. The majority of phases in all calcination temperature contained manganese oxides phases. Comparison of these results at different calcination temperatures for Cu_{0.2}Mn_{2.8}O₄ bulk powder indicates that this ratio of Cu—Mn is not effective for optimization in spinel phase formation and spinel phase stability.

### Example #2

### Cu_{0.5}Mn_{2.5}O₄ Bulk Powder

Cu—Mn solution may be prepared by mixing the appropriate amount of Mn nitrate solution (MnNO₃) and Cu nitrate solution (CuNO₃), with water to make solution at specific molar ratio according to formulation CuₓMn₃₋ₓO₄, in which X may take values of 0.5. For preparation of Cu_{0.5}Mn_{2.5}O₄ bulk powder, after precipitation of Cu—Mn solution with appropriate base solution, the slurry may undergo filtering and washing followed by drying calcination at a plurality of temperatures of about 600° C., 800° C., 900° C., 1000° C. and 1,100° C. for about 5 hours. The prepared powder at different calcination temperatures may be subsequently ground to fine grain to form bulk powder.

FIG. 2 depicts XRD analysis 200 for spinel phase formation of Cu_{0.5}Mn_{2.5}O₄ spinel in example #2, fired at about 600° C., according to an embodiment.

XRD spectrum 202 shows that Cu—Mn spinel forms in sample of Cu_{0.5}Mn_{2.5}O₄ calcined at about 600° C. Solid triangle markers 204 correspond to Cu_{0.5}Mn_{2.5}O₄ spinel phase. The remaining diffraction peaks, solid lines 206, correspond to a phase of Mn₂O₃.

FIG. 3 illustrates XRD analysis 300 for phase stability of Cu_{0.5}Mn_{2.5}O₄ spinel in example #2, calcined at about 900° C., according to an embodiment.

XRD spectrum 302 shows that Cu—Mn spinel remains stable in sample of Cu_{0.5}Mn_{2.5}O₄ calcined at about 900° C. Solid lines 304 correspond to stable Cu_{0.5}Mn_{2.5}O₄ spinel phase. The remaining diffraction peaks, solid circular markers 306 correspond to diffraction peaks of a phase of small formation of Mn₂O₃ and a new phase of small Mn₃O₄ that forms, as indicated by diffraction peaks of solid triangle markers 308 respectively.

FIG. 4 shows XRD analysis 400 for phase stability of Cu_{0.5}Mn_{2.5}O₄ spinel in example #2, calcined at about 1,000° C., according to an embodiment.

XRD spectrum 402 shows that Cu—Mn spinel remains stable in sample of Cu_{0.5}Mn_{2.5}O₄ calcined at about 1,000° C. Solid lines 404 correspond to stable Cu_{0.5}Mn_{2.5}O₄ spinel phase. The remaining diffraction peaks, solid square markers 406, correspond to a phase of Mn₃O₄ that forms.

FIG. 5 depicts XRD analysis 500 for phase stability of Cu_{0.5}Mn_{2.5}O₄ spinel in example #2, calcined at about 1,100° C., according to an embodiment.

XRD spectrum 502 shows that more Cu—Mn spinel remains stable in sample of Cu_{0.5}Mn_{2.5}O₄ calcined at about 1,100° C. Solid lines 504 correspond to stable Cu_{0.5}Mn_{2.5}O₄ spinel phase. The remaining diffraction peaks correspond to a phase in which Mn₃O₄ exist. However the amount of spinel phase dominates.

As may be observed, Cu_{0.5}Mn_{2.5}O₄ spinel phase forms at about 600° C. and remains stable until about 1,100° C., as shown in the XRD analyses depicted in FIG. 2, FIG. 3, FIG. 4, and FIG. 5. XRD analysis for spinel phase formation and phase stability of Cu_{0.5}Mn_{2.5}O₄ spinel in example #2, calcined at about 800° C. (not shown) resulted in a phase of stable Cu—Mn spinel formation in sample of Cu_{0.5}Mn_{2.5}O₄ and a phase of Mn₂O₃. Cu_{0.5}Mn_{2.5}O₄ spinel in example #2 presents phase stability at the range of calcination temperatures in present disclosure. Additionally, it may be noted that Mn₂O₃ transitions into Mn₃O₄ at temperatures higher than about 900° C., and lowering in intensity of Mn₃O₄ at about 1,100° C.

### Example #3

### Cu_{1.0}Mn_{2.0}O₄ bulk powder

Cu—Mn solution may be prepared by mixing the appropriate amount of Mn nitrate solution (MnNO₃) and Cu nitrate solution (CuNO₃), with water to make solution at specific molar ratio according to formulation CuₓMn₃₋ₓO₄, in which X may take values of 1.0. For preparation of Cu_{1.0}Mn_{2.0}O₄ bulk powder, after precipitation of Cu—Mn solution with appropriate base solution, the slurry may undergo filtering and washing followed by drying calcination at a plurality of temperatures of about 600° C., 800° C., 900° C., 1,000° C. and 1,100° C. for about 5 hours. The prepared powder at different calcination temperatures may be subsequently ground to fine grain to form bulk powder.

FIG. 6 shows XRD analysis 600 for spinel phase formation of Cu_{1.0}Mn_{2.0}O₄ spinel in example #3, calcined at about 600° C., according to an embodiment.

XRD spectrum 602 shows that stable Cu—Mn spinel phase forms in sample of Cu_{1.0}Mn_{2.0}O₄ calcined at about 600° C. Solid lines 604 correspond to stable Cu_{1.0}Mn_{2.0}O₄ spinel phase. The remaining diffraction peaks correspond to a phase in which CuO forms, as indicated by solid triangle markers 606.

FIG. 7 illustrates XRD analysis 700 for spinel phase stability of Cu_{1.0}Mn_{2.0}O₄ spinel in example #3, at different firing temperatures, according to an embodiment. XRD spectrum 702 shows Cu_{1.0}Mn_{2.0}O₄ spinel calcined at 800° C.; XRD spectrum 704 depicts Cu_{1.0}Mn_{2.0}O₄ spinel calcined at 900° C.; and XRD spectrum 706 show Cu_{1.0}Mn_{2.0}O₄ spinel calcined at about 1,000° C.

As may be observed in FIG. 7, Cu_{1.0}Mn_{2.0}O₄ spinel phase is shown as solid lines 708 and remaining diffraction peaks represent formation of CuO. XRD spectrum 702 presents a phase including mostly Cu_{1.0}Mn_{2.0}O₄ spinel formation and a phase of small formation of CuO at 800° C. XRD spectrum 704 and XRD spectrum 706 shows spinel phase is partially stable at about 900° C. and about 1,000° C. stability, because intensity of Cu—Mn spinel decreased by increasing temperature to about 1,000° C.

FIG. 8 shows XRD analysis 800 for spinel phase formation phase stability of Cu_{1.0}Mn_{2.0}O₄ spinel in example #3, calcined at about 1,100° C., according to an embodiment.

As may be observed in XRD spectrum 802, at calcination temperature of about 1,100° C., there is no Cu_{1.0}Mn_{2.0}O₄ spinel phase; the diagram shows formation of two other phases including cuprite (Cu₂O) and manganese oxide (MnO₂). As can be seen in FIG. 8, solid lines 804 depict the formation of a Cu₂O phase and the remaining diffraction peaks depict MnO₂ phase. This result shows Cu_{1.0}Mn_{2.0}O₄ spinel is not stable at calcination temperature of about 1,100° C.

As seen from FIG. 6, FIG. 7, and FIG. 8, Cu_{1.0}Mn_{2.0}O₄ spinel in example #3 shows that the stoichiometric ratio of Cu—Mn spinel is very effective for optimization in spinel phase formation and spinel phase stability. There exists enhanced phase stability since Cu_{1.0}Mn_{2.0}O₄ spinel phase formation starts at about 600° C. and continues showing stable manner until a temperature of about 1,000° C., while at a temperature of about 1,100° C. Cu_{1.0}Mn_{2.0}O₄ spinel decomposes to Cu and Mn oxides. The resulting phase stability of Cu_{1.0}Mn_{2.0}O₄ within a temperature range of about 600° C. to about 1,000° C. may lead to utilization of the Cu_{1.0}Mn_{2.0}O₄ spinel in underfloor and closed-loop coupled TWC applications.

### Example #4

### Cu_{1.5}Mn_{1.5}O₄ Bulk Powder

Cu—Mn solution may be prepared by mixing the appropriate amount of Mn nitrate solution (MnNO₃) and Cu nitrate solution (CuNO₃), with water to make solution at specific molar ratio according to formulation CuₓMn₃₋ₓO₄, in which X may take values of 1.5. For preparation of Cu_{1.5}Mn_{1.5}O₄ bulk powder, after precipitation of Cu—Mn solution with appropriate base solution, the slurry may undergo filtering and washing followed by drying calcination at a plurality of temperatures of about 500° C., 700° C., 900° C., and 1,100° C. for about 5 hours. The prepared powder at different calcination temperatures may be subsequently ground to fine grain to form bulk powder.

FIG. 9 illustrates XRD analysis 900 for spinel phase formation and phase stability of Cu_{1.5}Mn_{1.5}O₄ spinel fired at about 900° C., according to an embodiment.

Samples of Cu_{1.5}Mn_{1.5}O₄ spinel may be treated at about 500° C., 700° C., 900° C., and 1,100° C. Subsequently, spinel phase formation and spinel phase stability may be analyzed with XRD analysis. The results from the different analyses indicate that at about 500° C. only a phase of Cu_{0.5}Mn_{0.5}O₂ oxide is present; at about 700° C. a phase of Cu_{1.5}Mn_{1.5}O₄ spinel forms along with a phase of CuO, but Cu_{1.5}Mn_{1.5}O₄ spinel is not stable at higher temperature, because the resulting phases, at about 900° C., are Cu_{0.5}Mn_{0.5}O₂ oxide and CuO.

In XRD spectrum 902, solid lines 904 shows formation of Cu_{0.5}Mn_{0.5}O₂ oxide, while the remaining diffraction peaks show formation of CuO. The formation of Cu_{1.5}Mn_{1.5}O₄ spinel is not stable at higher temperatures because it decomposes very quickly even at about 900° C.

Comparison of these results at different calcination temperatures for Cu_{1.5}Mn_{1.5}O₄ bulk powder indicates that this ratio of Cu—Mn is not effective for optimization in spinel phase formation and spinel phase stability.

From example #1, example #2, example #3, and example #4 and the results from XRD analyses in present disclosure it may be observed dependency of spinel phase formation and stability on Cu—Mn mole ratios, that the spinel phase formation and thermal stability of CuₓMn₃₋ₓO₄ spinel may vary by Cu molar ratio, X. At about X=0.2, spinel may only partially form at very high temperature in the range of 900° C. It may seem that for CuₓMn₃₋ₓO₄ where at about X=0.5 and about X=1.0, spinel may form at about 600° C. and shows stability until about 1,000° C. In CuₓMn₃₋ₓO₄ where at about X=1.5, spinel only exist at about 900° C. and will decompose at temperature above that. The resulting stability may lead to consider the range of about 0.5≦X≦1.0 a region for developing Cu—Mn spinel according to the principles in present disclosure.

As enhanced stability may be achieved using ratios within a range of about 0.5 and 1.0, for Cu_{0.5}Mn_{2.5}O₄ spinel and Cu_{1.0}Mn_{2.0}O₄ spinel, lattice parameter and crystallite size may be calculated using XRD analyses to measure the effect of calcination temperature on the spinel phases that forms separately at each temperature.

Spectra may be recorded with scans from a plurality of steps at two-theta angle. Cu—Mn spinel lattice parameters may be calculated from reflections appearing in the two-theta range using a plurality of software programs by considering cubic symmetry of spinel structure.

Effect of Calcination Temperature on Lattice Parameters

FIG. 10 depicts variation of lattice parameters 1000 of Cu_{0.5}Mn_{2.5}O₄ and Cu_{1.0}Mn_{2.0}O₄ spinels fired at different temperatures, according to an embodiment. The graphs compare the influence of Cu—Mn ratio of spinel structure and calcination temperature on lattice parameter of spinel phase. The lattice parameters for Cu_{0.5}Mn_{2.5}O₄ and Cu_{1.0}Mn_{2.0}O₄ spinels as may be obtained from XRD analyses performed on bulk powder samples of Cu_{0.5}Mn_{2.5}O₄ and Cu_{1.0}Mn_{2.0}O₄.

Lattice parameter curve 1002 depicts variation of lattice parameters for Cu_{0.5}Mn_{2.5}O₄ bulk powder and lattice parameter curve 1004 shows variation of lattice parameters for Cu_{1.0}Mn_{2.0}O₄ bulk powder.

XRD analyses for Cu_{0.5}Mn_{2.5}O₄ bulk powder at calcination temperatures from about 600° C. to about 1,100° C. indicated spinel structure with cubic symmetry, i.e., a=b=c and α=β=γ. In lattice parameter curve 1002 may be seen that lattice parameter for spinel phase at about 600° C. is 8.236 Å, for spinel phase at about 800° C. is 8.276 Å, for spinel phase at about 900° C. is 8.294 Å, for spinel phase at about 1,000° C. is 8.328 Å, and for spinel phase at about 1,100° C. is 8.364 Å.

XRD analyses for Cu_{1.0}Mn_{2.0}O₄ bulk powder at calcination temperatures from about 600° C. to about 1,100° C. indicated spinel structure with cubic symmetry, i.e., a=b=c and α=β=γ. In lattice parameter curve 1004 may be seen that lattice parameter for spinel phase at about 600° C. is 8.201 Å, for spinel phase at about 800° C. is 8.225 Å, for spinel phase at about 900° C. is 8.241 Å, and for spinel phase at about 1,000° C. is 8.277 Å. As shown in FIG. 8, spinel does not exist at temperature of about 1,100° C.

As may be seen from the measured lattice parameters in lattice parameter curves 1002, 1004, as ionic radii of Cu ion is smaller than Mn ion on the same sites, the lattice parameter decreases when copper ions replace manganese ions. Additionally, it may be noted that as calcination temperature may be increased, the lattice parameter increases in both Cu_{0.5}Mn_{2.5}O₄ and Cu_{1.0}Mn_{2.0}O₄, and that increasing Cu molar ratio results in decreased lattice parameter.

At higher temperature Cu ions occupy the octahedral site and as larger Mn ions dominate the critical tetrahedral site, the lattice parameter increases and diffraction peaks in XRD analysis may shift to lower 2-theta positions. Thus, as lattice parameter decreases due to increased Cu molar ratio, diffraction peaks may shift to higher 2-theta positions. It may also be observed that for spinel with higher Cu molar ratio, there is an increase in lattice parameter and a decrease in 2-theta positions as calcination temperature is higher.

As may be observed in present disclosure, both Cu_{0.5}Mn_{2.5}O₄ and Cu_{1.0}Mn_{2.0}O₄ bulk powders may provide optimal spinel phase formation and thermal stability at different temperatures, as well as present enhanced behavior of high thermal stability at higher temperatures. Most particularly, optimal phase stability and catalytic performance, in close-coupled and underfloor catalytic converters of ZPGM catalyst systems in TWC applications, may be achieved using CuₓMn₃₋ₓO₄ material where 0.5≦X≦1.0.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A method of making a catalytic material, comprising:
providing at least one solution comprising Cu and Mn;
precipitating the at least one solution to form at least one precipitate;
heating the at least one precipitate; and
forming at least one catalyst having a general formula of CuₓMn₃₋ₓO₄;
wherein x is at least 0.5.

2. The method of claim 1, wherein x is less than 1.0.

3. The method of claim 1, wherein the heating is to at least 600° C.

4. The method of claim 1, wherein the heating is to at least 1100° C.

5. The method of claim 1, wherein the heating occurs for about 5 hours.

6. The method of claim 1, wherein the at least one catalyst comprises spinel structures.

7. The method of claim 1, wherein the at least one catalyst is substantially free of platinum group metals.

8. The method of claim 1, wherein the at least one catalyst is thermally stable.

9. The method of claim 1, wherein x is 1.5 and wherein the heating is to at least 700° C.

10. The method of claim 1, further comprising applying the at least one catalyst to a substrate using the same temperature as said heating.

11. A catalyst comprising: at least one oxygen storage material in the form of spinel having a general formula of Cu_{0.5}Mn_{2.5}O₄, wherein the spinel is stable at about 600° C. to about 1100° C.

12. A catalyst comprising: at least one oxygen storage material in the form of spinel having a general formula of Cu_{1.0}Mn_{2.0}O₄, wherein the spinel is stable at about 600° C. to about 1100° C.

13. A catalyst system, comprising:
at least one close-couple converter; and
at least one underfloor converter;
wherein the underfloor converter comprises a catalyst system, comprising:
a substrate; and
a washcoat suitable for deposition on the substrate, comprising at least one oxygen storage material;
wherein the at least one oxygen storage material comprises Cu—Mn spinel having a niobium-zirconia support oxide; and
wherein the Cu—Mn spinel was formed using a method comprising:
providing at least one solution comprising Cu and Mn;
precipitating the at least one solution to form at least one precipitate;
heating the at least one precipitate; and
forming at least one catalyst having a general formula of CuₓMn₃₋ₓO₄;
wherein x is at least 0.5.

14. The method of claim 13, wherein x is less than 1.0.

15. The method of claim 13, wherein the heating is to at least 600° C.

16. The method of claim 13, wherein the heating is to at least 1100° C.

17. The method of claim 13, wherein the heating occurs for about 5 hours.

18. The method of claim 13, wherein the at least one catalyst comprises spinel structures.

19. The method of claim 13, wherein the at least one catalyst is substantially free of platinum group metals.

20. The method of claim 13, wherein the at least one catalyst is thermally stable.

21. The method of claim 13, wherein x is 1.5 and wherein the heating is to at least 700° C.

22. The method of claim 13, further comprising applying the at least one catalyst to a substrate using the same temperature as said heating.
